(19) United States
(12) Patent Application Publication
(10) Pub. No.: US 2026/0329015 A1
(43) Pub. Date: Oct. 22, 2026

(54) FERRULE ALIGNMENT STRUCTURES FOR FIBER OPTIC CONNECTION SYSTEMS

(71) Applicant: Senko Advanced Components, Inc., Hudson, MA (US)

(72) Inventors: Kazuyoshi TAKANO, Tokyo (JP); Gang XU, Shenzhen (CN); Emmanuel KOLCZYNSKI, Walpole, MA (US); Ky LY, Shenzhen (CN); Anxiang LIAO, Shenzhen (CN); Takeshi KASAI, Shenzhen (CN); Hanyu ZOU, Shenzhen (CN); Siu Kei MA, Kowloon (HK)

(21) Appl. No.: 19/655,466

(22) Filed: Apr. 22, 2026

Related U.S. Application Data
(60) Provisional application No. 63/792,354, filed on Apr. 22, 2025.

(51) Int. Cl. G02B 6/38

(52) U.S. Cl. CPC G02B 6/3825; G02B 6/3831; G02B 6/3874

(57) ABSTRACT

Fiber optic connection components for connecting orientation-sensitive ferrules are disclosed. An adapter for orientation-sensitive ferrules has a ferrule alignment sleeve and a ferrule alignment key in the interior of the ferrule alignment sleeve. The ferrule alignment key engages grooves on orientation-sensitive ferrules to rotationally align opposing ferrules and establish an optical connection. A connector for mating with such an adapter includes a connector housing. A ferrule assembly including an orientation-sensitive ferrule is received in the connector housing and has a keying surface configured to engage the ferrule alignment key disposed inside the ferrule alignment sleeve of the adapter to rotationally align the ferrule assembly.

### CROSS-REFERENCE TO RELATED APPLICATIONS

This application claims priority to U.S. Application No. 63/792,354, filed Apr. 22, 2025, which is hereby incorporated by reference in its entirety.

### FIELD

The present disclosure relates to fiber optic connection systems, and more particularly to ferrule alignment structures for concentrically and rotationally aligning orientation-sensitive ferrules in adapters for multicore fiber, polarization maintaining fiber, and multi-fiber applications.

### BACKGROUND

Optical fibers that require precise rotational orientation for proper optical coupling, such as polarization maintaining fibers and multicore fibers, present alignment challenges when incorporated into pluggable fiber optic connection systems. Polarization maintaining fibers include stress-applying structures that define slow and fast axes, and multicore fibers contain a plurality of fiber cores arranged in a pattern within a single cladding. For these orientation-sensitive fibers, the outer diameter may be on the order of 125 microns, making it challenging to align and mate the cores of one fiber with the corresponding cores of another fiber while accounting for the rotational orientation of the fiber structure. Once orientation-sensitive fibers are aligned and mated, the rotation of the fiber or ferrule holding the fiber may need to be inhibited to maintain proper optical coupling.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, an adapter for fiber optic connectors comprises an adapter housing defining a first receptacle and a second receptacle. The first receptacle is configured to receive a first connector, and the second receptacle configured to receive a second connector. The first connector comprises a first ferrule assembly including a first orientation-sensitive ferrule, and the second connector comprises a second ferrule assembly including a second orientation-sensitive ferrule. An adapter latch feature for latching with a complementary connector latch feature is on a connector housing of the first connector to secure the first connector in the first receptacle. A ferrule alignment sleeve is disposed within the adapter housing and defines a ferrule alignment axis. The ferrule alignment sleeve has an interior. The ferrule alignment sleeve is configured to receive the first orientation-sensitive ferrule and the second orientation-sensitive ferrule and concentrically align the first orientation-sensitive ferrule and the second orientation-sensitive ferrule on the ferrule alignment axis. A ferrule alignment key is disposed in the interior of the ferrule alignment sleeve. The ferrule alignment key is configured to engage a groove of the first ferrule assembly and a groove of the second ferrule assembly to rotationally align the first orientation-sensitive ferrule and the second orientation-sensitive ferrule to establish an optical connection when the first connector is received in the first receptacle and the second connector is received in the second receptacle.

In another aspect, a connector for fiber optic applications comprises a connector housing having a latch feature. A ferrule assembly is in the connector housing. The ferrule assembly includes an orientation-sensitive ferrule. A keying surface is on the ferrule assembly. The keying surface is configured to engage a ferrule alignment key disposed inside a ferrule alignment sleeve to rotationally align the ferrule assembly with a mating ferrule assembly.

In another aspect, a fiber optic connection system comprises a first connector comprising a first connector housing and a first ferrule assembly including a first orientation-sensitive ferrule. The first ferrule assembly has a first keying surface defining a first groove. A second connector comprises a second connector housing and a second ferrule assembly including a second orientation-sensitive ferrule. The second ferrule assembly has a second keying surface defining a second groove. An adapter comprises an adapter housing defining a first receptacle and a second receptacle. The first receptacle is configured to receive the first connector and the second receptacle configured to receive the second connector. A ferrule alignment sleeve is disposed within the adapter housing and defines a ferrule alignment axis. The ferrule alignment sleeve has an interior. The ferrule alignment sleeve is configured to receive the first orientation-sensitive ferrule and the second orientation-sensitive ferrule and concentrically align the first orientation-sensitive ferrule and the second orientation-sensitive ferrule on the ferrule alignment axis. A ferrule alignment key is disposed in the interior of the ferrule alignment sleeve. The ferrule alignment key is configured to engage the first groove of the first ferrule assembly and the second groove of the second ferrule assembly to rotationally align the first orientation-sensitive ferrule and the second orientation-sensitive ferrule to establish an optical connection when the first connector is received in the first receptacle and the second connector is received in the second receptacle.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a perspective of a fiber optic connection system in accordance with the present disclosure;

FIG. 2 is a perspective of a connector of the fiber optic connection system of FIG. 1;

FIG. 3 is an enlarged fragmentary perspective of the connector;

FIG. 4 is a perspective of an orientation-sensitive ferrule of the connector;

FIG. 5 is an enlarged fragmentary perspective of a first orientation-sensitive ferrule configuration;

FIG. 6 is an enlarged fragmentary perspective of a second orientation-sensitive ferrule configuration;

FIG. 7 is an enlarged fragmentary perspective of a third orientation-sensitive ferrule configuration;

FIG. 8 is an enlarged fragmentary perspective of an orientation-insensitive ferrule configuration;

FIG. 9 is a fragmentary longitudinal sectional perspective of the fiber optic connection system of FIG. 1;

FIG. 10 is an enlarged fragmentary perspective of an adapter of the fiber optic connection system of FIG. 1;

FIG. 11 is a perspective of a subassembly of the fiber optic connection system of FIG. 1, including an alignment plate and two orientation-sensitive ferrules in optically coupled relation;

FIG. 12 is an exploded perspective showing two orientation-sensitive ferrules in optically coupled relation, the alignment plate, and a spring;

FIGS. 13A and 13B are elevations showing engagement of a ferrule alignment key of a first alignment key configuration coming into engagement with a keying groove of an orientation-sensitive ferrule;

FIGS. 14A and 14B are elevations showing engagement of a ferrule alignment key of a second alignment key configuration coming into engagement with a keying groove of an orientation-sensitive ferrule;

FIGS. 15A and 15B are elevations showing engagement of a ferrule alignment key of a third alignment key configuration coming into engagement with a keying groove of an orientation-sensitive ferrule;

FIG. 16 is a perspective of another embodiment of a fiber optic connection system;

FIG. 17 is a perspective of a connector of the fiber optic connection system of FIG. 16;

FIG. 18 is an enlarged view of a portion of FIG. 17;

FIG. 19A is an enlarged fragmentary perspective of a fourth orientation-sensitive ferrule configuration;

FIG. 19B is an enlarged fragmentary perspective of a fifth orientation-sensitive ferrule configuration;

FIG. 19C is an enlarged fragmentary perspective of a sixth orientation-sensitive ferrule configuration;

FIG. 20 is an enlarged fragmentary perspective of an adapter of the fiber optic connection system of FIG. 16;

FIG. 21 is an enlarged fragmentary perspective in longitudinal section of the fiber optic connection system of FIG. 16;

FIG. 22 is an enlarged fragmentary cross-sectional perspective in longitudinal section of the adapter of the fiber optic connection system of FIG. 16;

FIG. 23 is an exploded perspective showing components of the fiber optic connection system of FIG. 16 including two orientation-sensitive ferrules in optically coupled relation, an alignment plate, and a spring;

FIG. 24 is a perspective of an adapter of another embodiment of a fiber optic connection system;

FIG. 25 is an exploded perspective of the adapter of FIG. 24;

FIG. 26 is a perspective of a connector for mating with the adapter of FIG. 24;

FIG. 27 is an exploded perspective of the connector of FIG. 26;

FIG. 28 is an exploded perspective showing components of a fiber optic connection system including a ferrule alignment sleeve and an alignment plate of the adapter of FIG. 24 and ferrule assemblies of two of the connectors of FIG. 26;

FIG. 29 is a perspective showing the components of FIG. 28 when the ferrule assemblies are concentrically and rotationally aligned by the ferrule alignment sleeve and the alignment plate;

FIG. 30 is a fragmentary cross section taken at a plane perpendicular to a ferrule alignment axis in FIG. 29;

FIGS. 31A-31C are a series of longitudinal sections showing mating of two connectors of FIG. 26 with the adapter of FIG. 24;

FIG. 32 is an exploded perspective of an adapter of another embodiment of a fiber optic connection system;

FIG. 33 is a perspective of a connector for mating with the adapter of FIG. 32;

FIG. 34 is an exploded perspective of the connector of FIG. 33;

FIG. 35 is an exploded perspective showing components of a fiber optic connection system including a ferrule alignment sleeve and an alignment sleeve sheath of the adapter of FIG. 32 and ferrule assemblies of two of the connectors of FIG. 33;

FIG. 36 is a perspective showing the components of FIG. 35 when the ferrule assemblies are concentrically and rotationally aligned by the ferrule alignment sleeve and the alignment sleeve sheath;

FIG. 37 is a cross section taken at a plane perpendicular to a ferrule alignment axis in FIG. 36;

FIGS. 38A-38C are a series of longitudinal sections showing mating of two connectors of FIG. 33 with the adapter of FIG. 32;

FIG. 39 is an exploded perspective of an adapter of another embodiment of a fiber optic connection system;

FIG. 40 is a perspective of a connector for mating with the adapter of FIG. 39;

FIG. 41 is an exploded perspective of the connector of FIG. 40;

FIG. 42 is an exploded perspective showing components of a fiber optic connection system including a ferrule alignment sleeve and an alignment plate of the adapter of FIG. 39 and ferrule assemblies of two of the connectors of FIG. 40;

FIG. 43 is a perspective showing the components of FIG. 42 when the ferrule assemblies are concentrically and rotationally aligned by the ferrule alignment sleeve and the alignment plate;

FIG. 44 is a cross section taken at a plane perpendicular to a ferrule alignment axis in FIG. 43; and

FIGS. 45A-45C are a series of longitudinal sections showing mating of two connectors of FIG. 40 with the adapter of FIG. 39.

Reference numerals in the drawings correspond to like elements in the detailed description. Such reference numerals are used to facilitate an understanding of the disclosure and are not intended to be limiting.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Referring to the drawings, fiber optic connection systems for orientation-sensitive ferrules are generally indicated at reference numbers 100, 200, 300, 400, and 500. In general, each fiber optic connection system comprises an adapter and one or more connectors, wherein each connector includes a ferrule assembly having an orientation-sensitive ferrule configured to hold one or more optical fibers. The orientation-sensitive ferrule holds one or more optical fibers where the rotational orientation of the fiber or fibers is relevant to optical performance. Examples of orientation-sensitive ferrules include ferrules holding a polarization maintaining (PM) fiber, a multicore fiber (MCF), or a multi-fiber ferrule. Multi-fiber ferrules hold a plurality of individual optical fibers arranged in a pattern within the ferrule, wherein the individual fibers may be conventional single-mode or multimode fibers, polarization maintaining fibers, multicore fibers, or combinations thereof.

Polarization maintaining fibers include stress-applying parts arranged within the fiber cladding that create birefringence in the fiber core, thereby maintaining the polarization state of light propagating through the fiber. The stress-applying parts define a slow axis and a fast axis, and proper optical coupling between mated PM fibers requires alignment of these axes. Multicore fibers contain a plurality of fiber cores within a single fiber cladding, and proper optical coupling between mated MCFs requires alignment of the individual cores of one fiber with corresponding cores of a mating fiber. Multi-fiber ferrules require rotational alignment to ensure that each fiber in one ferrule is properly aligned with its corresponding fiber in a mating ferrule. In PM fiber, MCF, and multi-fiber ferrule applications, visual alignment of the internal fiber structure is challenging without mechanical alignment features.

In general, each fiber optic connection system described herein addresses the alignment challenge by providing a ferrule alignment sleeve (e.g., a cylindrical split sleeve or, more broadly, a cylindrical ferrule alignment sleeve) disposed within an adapter housing and a ferrule alignment key in the interior of the ferrule alignment sleeve. The ferrule alignment sleeve is configured to receive orientation-sensitive ferrules from mating connectors and concentrically align the orientation-sensitive ferrules on a ferrule alignment axis. The ferrule alignment key is configured to engage a groove on each ferrule assembly to rotationally align the orientation-sensitive ferrules and establish an optical connection. As will be explained in further detail below, the ferrule alignment key engages the grooves of both mated ferrule assemblies simultaneously, thereby preventing rotation of each ferrule and maintaining proper angular orientation of the fiber cores during and after mating operations.

The embodiments described herein include various configurations for the ferrule alignment key and the groove on the ferrule assembly. In some embodiments, the groove is located on a ferrule body of the orientation-sensitive ferrule. In other embodiments, the groove is located on a ferrule flange of the ferrule assembly. The ferrule alignment key is formed as part of an alignment plate in some embodiments, and the ferrule alignment key is formed as an integral tongue of an alignment sleeve sheath in other embodiments. The ferrule alignment key is spring-loaded in some embodiments, with a spring element or a panel clip providing a biasing force to urge the ferrule alignment key radially inward toward engagement with the ferrule assemblies.

The fiber optic connection systems described herein are compatible with various connector form factors. In the illustrated embodiments, the connectors include LC-type connectors and very small form factor (VSFF) duplex connectors, such as SN-type connectors. The adapters include corresponding LC adapters and SN adapters configured to receive the respective connector types. The orientation-sensitive ferrules described herein may have either an angled physical contact (APC) end face or an ultra physical contact (UPC) end face. The ferrule alignment structures described herein are compatible with both APC and UPC end face configurations.

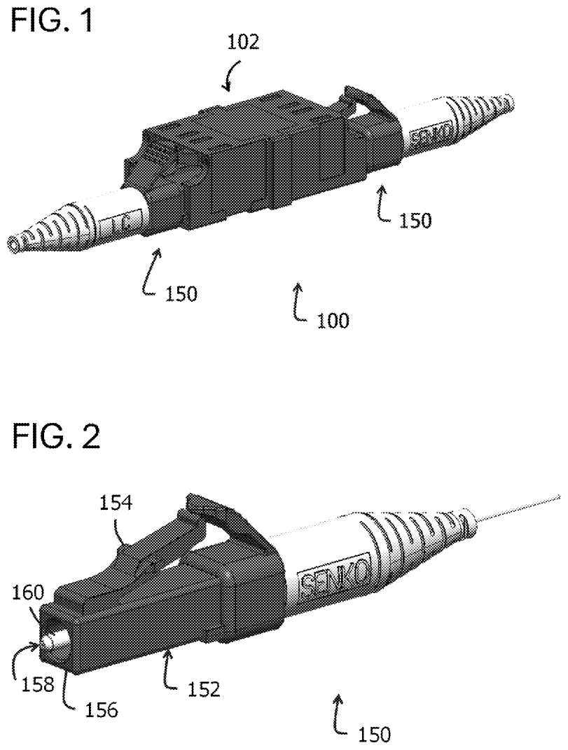

Referring to FIGS. 1-15B, one example embodiment of a fiber optic connection system is generally indicated at reference number 100. In general, the fiber optic connection system 100 comprises an adapter 102 and one or more connectors 150 configured to mate with the adapter. As will be explained in further detail below, the adapter 102 and the connectors 150 have complementary rotational alignment structures configured to ensure proper angular fiber alignment when the connectors are mated with the adapter.

Referring to FIGS. 2-4, the connector 150 will now be described in greater detail. In general, the connector 150 comprises a connector housing 152, a ferrule assembly 158 disposed within the connector housing 152, and a keying surface on the ferrule assembly 158 configured to engage a ferrule alignment key disposed inside a ferrule alignment sleeve (as will be described more fully below) to rotationally align the ferrule assembly 158 with a mating ferrule assembly. As will be explained in further detail below, the keying surface defines a groove 162 on the ferrule assembly 158 that cooperates with a keying element in the adapter 102 to establish proper rotational alignment between mated orientation-sensitive ferrules 160.

The illustrated connector housing 152 is an LC plug frame. Other connector types can also be used without departing from the scope of the disclosure. As an LC plug frame, the connector 150 has a generally rectangular profile and includes a latch arm 154 extending from an upper surface of the connector housing 152. The latch arm 154 serves as a connector latch feature configured to engage with a complementary adapter latch feature on the adapter 102 to secure the connector 150 within a receptacle of the adapter 102. The connector housing 152 further includes a rim 156 at a forward portion of the connector housing 152. The rim 156 defines an opening through which the ferrule assembly 158 extends.

The ferrule assembly 158 is disposed within the connector housing 152 and includes an orientation-sensitive ferrule 160. The orientation-sensitive ferrule 160 is a cylindrical component configured to hold one or more optical fibers. The orientation-sensitive ferrule 160 extends along a ferrule center axis 166 and has a length L1. The length L1 includes a leading half and a trailing half, wherein the leading half is the portion of the orientation-sensitive ferrule 160 that is inserted first into the ferrule alignment sleeve 112 during mating operations.

With continued reference to FIG. 4, the orientation-sensitive ferrule 160 includes the groove 162 formed on an outer surface of the orientation-sensitive ferrule 160. The groove 162 serves as a keying surface configured to engage with the ferrule alignment key 118 disposed inside the ferrule alignment sleeve 112. The groove 162 extends longitudinally along a portion of the orientation-sensitive ferrule 160 and is oriented parallel to the ferrule center axis 166. In the illustrated embodiment, the groove 162 is located entirely along the leading half of the orientation-sensitive ferrule 160. This positioning of the groove 162 along the leading half facilitates engagement with the ferrule alignment key 118 as the orientation-sensitive ferrule 160 is inserted into the ferrule alignment sleeve 112.

In this embodiment, the groove 162 is V-shaped in cross section. In other embodiments, other groove shapes, or more broadly, other rotational keying surface configurations are possible without departing from the scope of the disclosure. The V-shaped cross-sectional shape of the groove 162 is configured to provide self-centering engagement with a complementary key structure within the adapter 102, thereby facilitating precise rotational alignment of the orientation-sensitive ferrule 160. The ferrule assembly 158 is pre-terminated on one or more optical fibers so that the groove 162 is precisely oriented and positioned with respect to the fiber cores held within the orientation-sensitive ferrule 160. In this way, engagement of the ferrule alignment key 118 with the groove 162 establishes proper angular orientation of the fiber cores for optical coupling with a mating ferrule assembly.

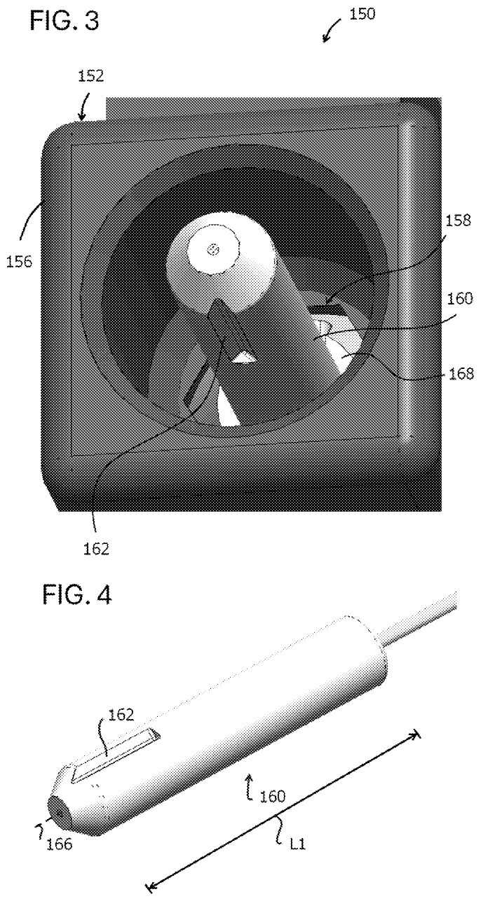

Referring again to FIG. 3, the ferrule assembly 158 further includes a ferrule flange 168 positioned on the ferrule assembly 158. The ferrule flange 168 has a non-cylindrical cross-section that is larger than the cylindrical body of the orientation-sensitive ferrule 160. The non-cylindrical cross-section of the ferrule flange 168 constrains the ferrule assembly 158 to one or a limited number of rotational positions within the connector housing 152. Because the ferrule flange 168 constrains the rotational position of the ferrule assembly 158 within the connector housing 152, the angular relationship between the ferrule flange 168 and the groove 162 is precisely controlled during fiber termination and/or ferrule manufacturing. The groove 162 is oriented and positioned with respect to the fiber cores held within the orientation-sensitive ferrule 160, and the ferrule flange 168 is angularly indexed to the groove 162 so that when the ferrule flange 168 is received in the connector housing 152, the groove 162 is held at the correct angular position for engagement with the ferrule keying structure in the adapter 102. In this way, each fiber optic connection system 100 maintains angular fidelity to ensure proper rotational orientation of the fiber cores for optical coupling. The ferrule flange 168 also cooperates with a spring element within the connector housing 152 to allow axial movement of the orientation-sensitive ferrule 160 during mating operations, thereby providing compliance when the orientation-sensitive ferrule 160 contacts a mating ferrule within the ferrule alignment sleeve 112.

Although the ferrule flange 168 constrains the ferrule assembly 158 to one or a limited number of rotational positions within the connector housing 152, and the connector housing 152 is received in the adapter 102 in a rotationally fixed orientation, the ferrule alignment key 118 engaging the groove 162 provides direct, fine ferrule-to-ferrule rotational alignment that supplements the chain of angular alignment described above. The connector housing 152 and the adapter housing 104 are typically molded from polymer materials and may have looser dimensional tolerances than the ceramic orientation-sensitive ferrule 160 and the optical fiber cores held therein. Accumulated tolerance stack-up across the ferrule flange 168, the connector housing 152, and the adapter housing 104 may introduce small rotational errors that are unacceptable for orientation-sensitive fiber configurations requiring sub-degree angular precision. The ferrule alignment key 118 engaging the groove 162 directly at the ferrule-to-ferrule mating interface bypasses these intermediate tolerance contributions, providing a direct mechanical reference between the two mating orientation-sensitive ferrules 160 that is independent of the dimensional accuracy of the polymer housing components.

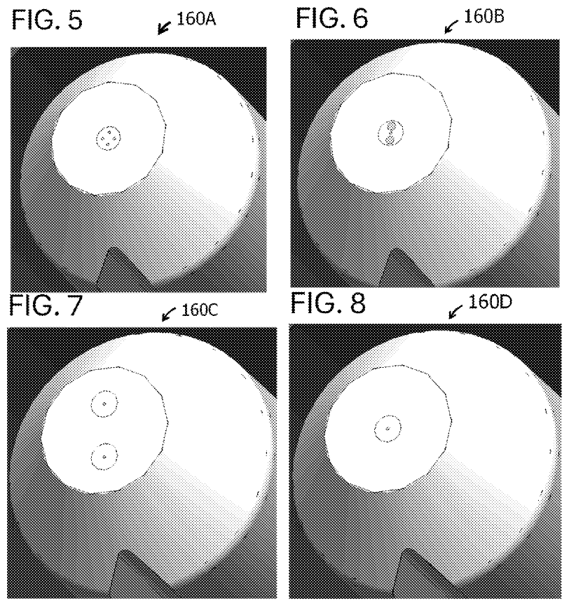

Referring to FIGS. 5-8, various orientation-sensitive ferrule configurations are illustrated. In general, the orientation-sensitive ferrule 160 is configured to hold one or more optical fibers where the rotational orientation of the fiber or fibers is relevant to optical performance. The orientation-sensitive ferrule 160 includes a groove 162 on the ferrule body that is oriented and positioned with respect to the fiber cores held within the orientation-sensitive ferrule 160. As will be explained in further detail below, the groove 162 engages with the ferrule alignment key 118 in the adapter 102 to establish proper rotational alignment between mated orientation-sensitive ferrules 160.

Referring to FIG. 5, a first orientation-sensitive ferrule configuration 160A is illustrated. The first orientation-sensitive ferrule configuration 160A is configured to hold a multicore fiber having a plurality of fiber cores arranged in a pattern within a single fiber cladding. In the illustrated embodiment, the first orientation-sensitive ferrule configuration 160A holds a four-core multicore fiber, wherein four fiber cores are arranged in a clustered pattern at the center of the ferrule end face. Proper optical coupling between mated multicore fibers requires alignment of the individual cores of one fiber with corresponding cores of a mating fiber, and the groove 162 facilitates this alignment by engaging with the ferrule alignment key 118.

Referring to FIG. 6, a second orientation-sensitive ferrule configuration 160B is illustrated. The second orientation-sensitive ferrule configuration 160B is configured to hold a polarization maintaining fiber. Polarization maintaining fibers include stress-applying parts arranged within the fiber cladding that create birefringence in the fiber core, thereby maintaining the polarization state of light propagating through the fiber. The stress-applying parts define a slow axis and a fast axis. In the illustrated embodiment, the second orientation-sensitive ferrule configuration 160B holds a polarization maintaining fiber having a single fiber core at the center of the ferrule end face. The groove 162 on the second orientation-sensitive ferrule configuration 160B is oriented with respect to the slow axis or the fast axis of the polarization maintaining fiber. Proper optical coupling between mated polarization maintaining fibers requires alignment of the slow axis of one fiber with the slow axis of a mating fiber, and the groove 162 facilitates this alignment.

With continued reference to FIG. 7, a third orientation-sensitive ferrule configuration 160C is illustrated. The third orientation-sensitive ferrule configuration 160C is configured to hold a multi-fiber ferrule arrangement. In the illustrated embodiment, the third orientation-sensitive ferrule configuration 160C holds two optical fibers arranged in a vertically stacked configuration within the ferrule end face. Each of the two optical fibers has a fiber core positioned within a respective circular region on the ferrule end face. The groove 162 on the third orientation-sensitive ferrule configuration 160C is oriented and positioned with respect to the arrangement of the two fiber cores. The two fibers held within the third orientation-sensitive ferrule configuration 160C are individual optical fibers that are conventional single-mode fibers, multimode fibers, polarization maintaining fibers, multicore fibers, or combinations thereof.

Referring to FIG. 8, a fourth ferrule configuration 160D is illustrated. Unlike the first, second, and third orientation-sensitive ferrule configurations 160A, 160B, and 160C, the fourth ferrule configuration 160D is configured to hold a conventional single-core optical fiber, such as a single-mode fiber or a multimode fiber, where the optical performance of the fiber does not depend on rotational orientation. The fourth ferrule configuration 160D is an orientation-insensitive configuration.

The various orientation-sensitive ferrule configurations 160A, 160B, and 160C described above are example configurations, and other configurations are possible without departing from the scope of the disclosure. In each configuration, the groove 162 or other keying surface is oriented and positioned with respect to the fiber cores held within the orientation-sensitive ferrule 160, such that engagement of the adapter keying structure with the groove 162 establishes proper angular orientation of the fiber core(s) for optical coupling with a mating ferrule assembly. As illustrated by the orientation-insensitive ferrule configuration 160D, the alignment system is also compatible with orientation-insensitive fiber configurations.

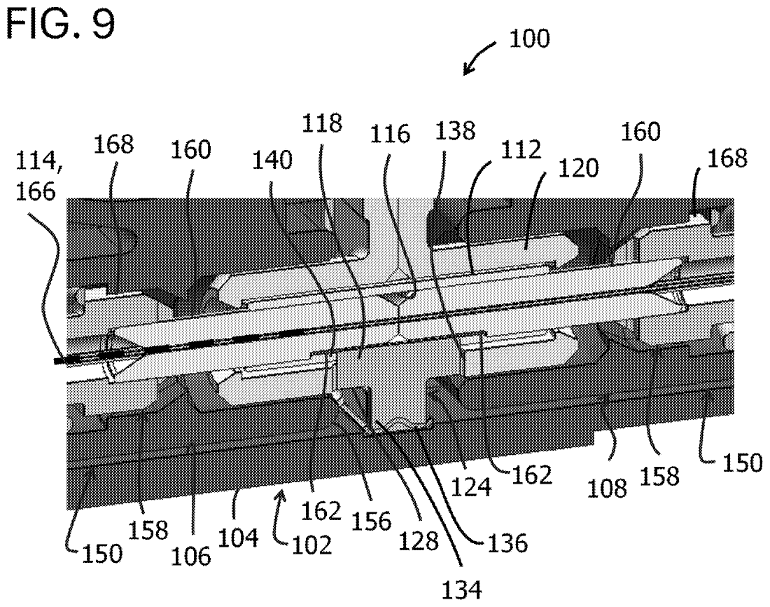

Referring to FIGS. 9-12, the adapter 102 will now be described in greater detail. In general, the adapter 102 comprises an adapter housing 104 defining a first receptacle 106 and a second receptacle 108, a ferrule alignment sleeve 112 disposed within the adapter housing 104, an alignment sleeve holder 120 holding the ferrule alignment sleeve 112, and a ferrule alignment key 118 disposed in an interior 116 of the ferrule alignment sleeve 112. As will be explained in further detail below, the ferrule alignment key 118 engages the grooves 162 of both mated ferrule assemblies 158 simultaneously to rotationally align the orientation-sensitive ferrules 160 and establish an optical connection.

Referring to FIG. 9, the adapter housing 104 defines the first receptacle 106 and the second receptacle 108 on opposite ends of the adapter 102. The first receptacle 106 is configured to receive a first connector 150, and the second receptacle 108 is configured to receive a second connector 150. The ferrule alignment sleeve 112 is disposed within the adapter housing 104 and defines a ferrule alignment axis 114 (e.g., the ferrule alignment axis 114 can be the center axis of the ferrule alignment sleeve 112). The interior 116 of the ferrule alignment sleeve 112 is configured to receive the orientation-sensitive ferrules 160 from the first connector 150 and the second connector 150. The ferrule alignment sleeve 112 concentrically aligns the orientation-sensitive ferrules 160 on the ferrule alignment axis 114 when the connectors 150 are received in the first receptacle 106 and the second receptacle 108. For example, the ferrule center axis 166 of each orientation-sensitive ferrule 160 is coaxial with the ferrule alignment axis 114 when the orientation-sensitive ferrules 160 are properly positioned within the ferrule alignment sleeve 112.

In one or more embodiments, the ferrule alignment key 118 has a tapered or rounded leading edge that facilitates entry of the ferrule alignment key 118 into the groove 162 as the orientation-sensitive ferrule 160 is inserted into the cylindrical ferrule alignment sleeve 112. The tapered or rounded leading edge of the ferrule alignment key 118 acts as a cam surface that guides the ferrule alignment key 118 into the groove 162 even when there is initial rotational misalignment between the ferrule alignment key 118 and the groove 162. The spring-loaded configuration of the ferrule alignment key 118 further facilitates entry by allowing the ferrule alignment key 118 to be displaced radially outward by the outer surface of the orientation-sensitive ferrule 160 and then snap radially inward into the groove 162 when the groove 162 passes the ferrule alignment key 118.

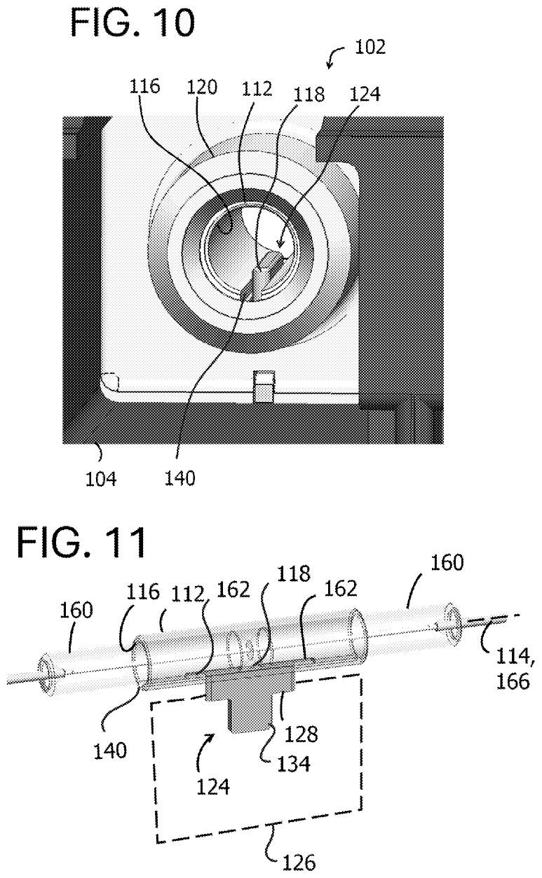

Referring to FIG. 10, the alignment sleeve holder 120 is disposed within the adapter housing 104 and holds the ferrule alignment sleeve 112 in position. The alignment sleeve holder 120 defines an outer slot 138 (FIG. 9) that extends through the alignment sleeve holder 120. The ferrule alignment sleeve 112 defines an inner slot 140 that extends through the wall of the ferrule alignment sleeve 112. The outer slot 138 and the inner slot 140 are aligned to receive an alignment plate 124. In the illustrated embodiment, the ferrule alignment key 118 is defined by an inner edge margin of the alignment plate. The alignment plate 124 is positioned in the outer slot 138 and the inner slot 140 such that the ferrule alignment key 118 protrudes from the outer slot 138 and the inner slot 140 into the interior 116 of the ferrule alignment sleeve 112.

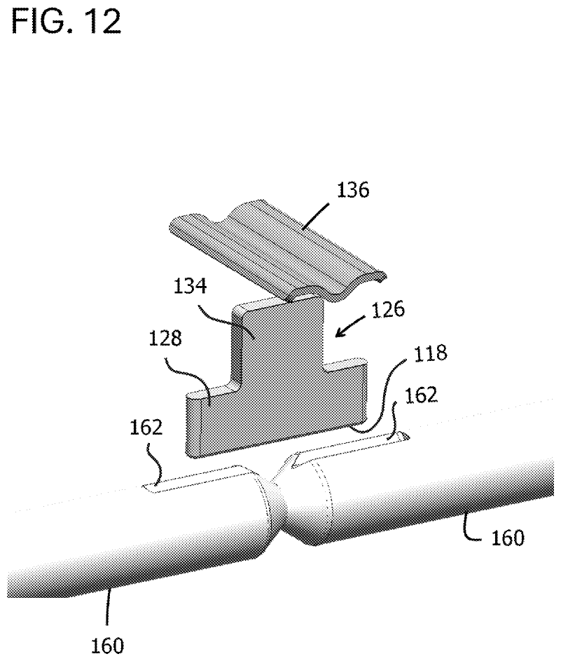

Referring to FIGS. 11 and 12, the alignment plate 124 extends in a plate plane 126. The ferrule alignment axis 114 lies in the plate plane 126. The alignment plate 124 includes an inner flange 128 proximate to the ferrule alignment axis 114. The inner flange 128 has an inner edge margin that defines the ferrule alignment key 118. The ferrule alignment key 118 protrudes radially inward into the interior 116 of the ferrule alignment sleeve 112 to engage the grooves 162 of the ferrule assemblies 158. The alignment plate 124 further comprises a web 134 extending transversely outward from the inner flange 128. The web 134 is shorter along the ferrule alignment axis 114 than the inner flange 128 to define a clearance for the rims 156 of the connector housings 152 of the first and second connectors 150. The clearance provided by the web 134 allows the rims 156 of the connector housings 152 to pass adjacent to the alignment plate 124 when the ferrule alignment key 118 is engaged with the grooves 162 of the ferrule assemblies 158. The inner flange 128 has a height that is short enough to fit in the radial spaces between the grooves 162 and the rims 156.

Referring again to FIG. 9, the adapter 102 further includes a spring 136 configured to yieldably bias the ferrule alignment key 118 radially inward relative to the ferrule alignment axis 114 toward engagement with the first ferrule assembly 158 and the second ferrule assembly 158. The spring 136 is positioned above the web 134 of the alignment plate 124 and exerts a downward force on the alignment plate 124, urging the ferrule alignment key 118 into the grooves 162 of the orientation-sensitive ferrules 160. In the illustrated embodiment, the spring 136 is configured as a wave spring, but other types of springs (e.g., coil springs, leaf springs, torsion springs, etc.) can also be used without departing from the scope of the disclosure. The spring-loaded configuration of the ferrule alignment key 118 ensures positive engagement with the grooves 162 and accommodates manufacturing tolerances in the ferrule assemblies 158 and the adapter components.

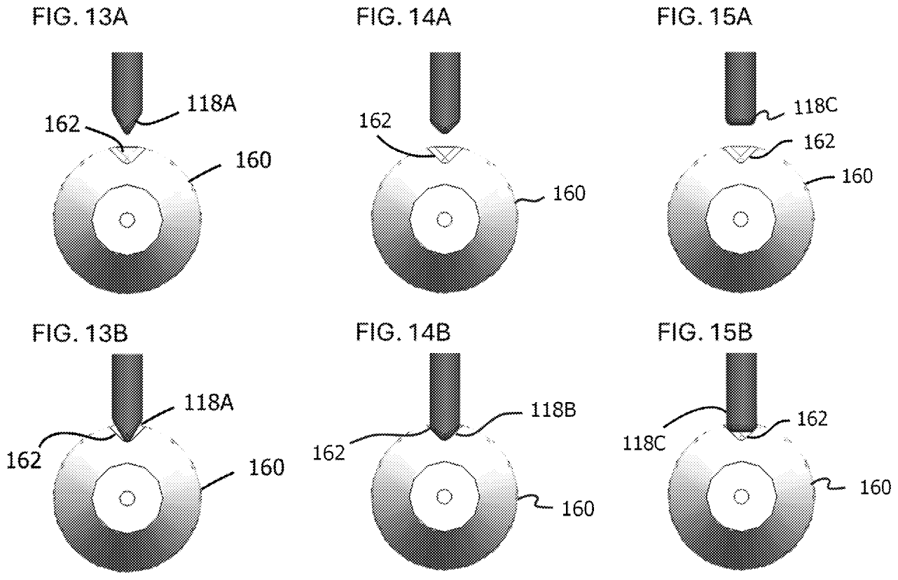

Referring to FIGS. 13A-13B, 14A-14B, and 15A-15B, three alignment key configurations are illustrated. FIGS. 13A and 13B show a first alignment key configuration 118A having a V-shaped tip with steeper side angles than the V-shaped groove 162, such that the first alignment key configuration 118A contacts the groove 162 adjacent the trough of the groove. FIGS. 14A and 14B show a second alignment key configuration 118B having a V-shaped tip with side angles that match the V-shaped profile of the groove 162, such that the second alignment key configuration 118B seats flush against the groove sidewalls. FIGS. 15A and 15B show a third alignment key configuration 118C having a rectangular cross-section, such that the end portion of the key engages the sidewalls of the groove 162 adjacent the top. In each configuration, engagement between the respective alignment key configuration and the groove 162 rotationally aligns the orientation-sensitive ferrule 160 to maintain the proper angular orientation of the fiber cores for high performance optical coupling.

In operation, the first connector 150 is inserted into the first receptacle 106 and the second connector 150 is inserted into the second receptacle 108. As the connectors 150 are inserted, the orientation-sensitive ferrules 160 enter the interior 116 of the ferrule alignment sleeve 112 from opposite ends. The ferrule alignment sleeve 112 concentrically aligns the orientation-sensitive ferrules 160 on the ferrule alignment axis 114, such that the ferrule center axis 166 of each orientation-sensitive ferrule 160 becomes coaxial with the ferrule alignment axis 114. As the orientation-sensitive ferrules 160 advance into the ferrule alignment sleeve 112, the orientation-sensitive ferrule 160 may contact the ferrule alignment key 118 and displaces the alignment plate 124 radially outward against the biasing force of the spring 136. The spring 136 maintains a radially inward force on the alignment plate 124 so that the ferrule alignment key 118 remains in sliding contact with the orientation-sensitive ferrule 160 as the ferrule advances. The spring 136 also urges the ferrule alignment key 118 radially inward into the groove 162. If the orientation-sensitive ferrule 160 is initially rotationally misaligned such that the groove 162 is not directly aligned with the ferrule alignment key 118, the tapered or rounded leading edge of the ferrule alignment key 118 and the V-shaped profile of the groove 162 cooperate to cam the orientation-sensitive ferrule 160 into rotational alignment as the spring 136 drives the ferrule alignment key 118 into the groove 162. The engagement between the ferrule alignment key 118 and the grooves 162 rotationally aligns the orientation-sensitive ferrules 160 to a common angular orientation. The ferrule alignment key 118 engages the grooves 162 of both orientation-sensitive ferrules 160 simultaneously, thereby preventing rotation of each orientation-sensitive ferrule 160 about the ferrule center axis 166 and maintaining proper angular orientation of the fiber cores during and after mating operations. When the connectors 150 are fully seated in the first receptacle 106 and the second receptacle 108, the end faces of the orientation-sensitive ferrules 160 contact one another within the ferrule alignment sleeve 112, and the concentric alignment provided by the ferrule alignment sleeve 112 together with the rotational alignment provided by the ferrule alignment key 118 establishes an optical connection between the fiber cores of the mated orientation-sensitive ferrules 160.

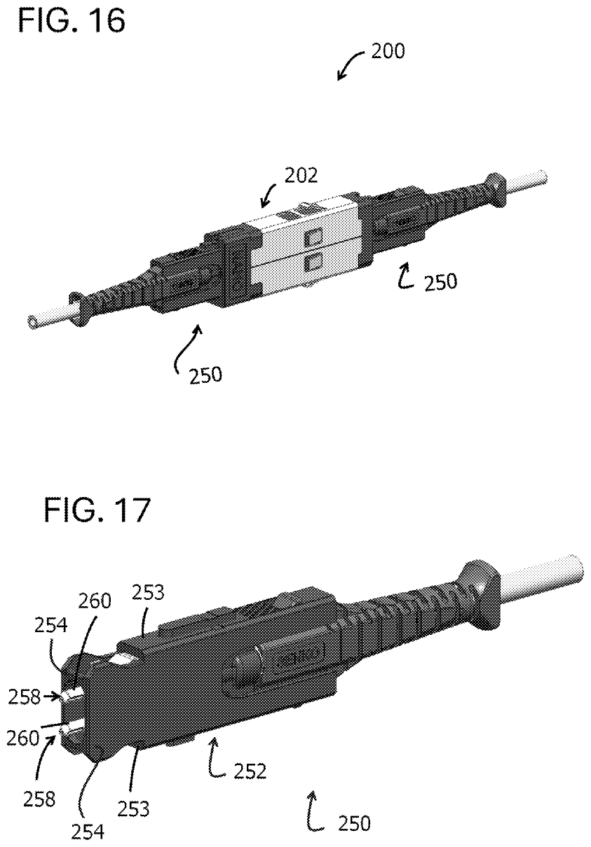

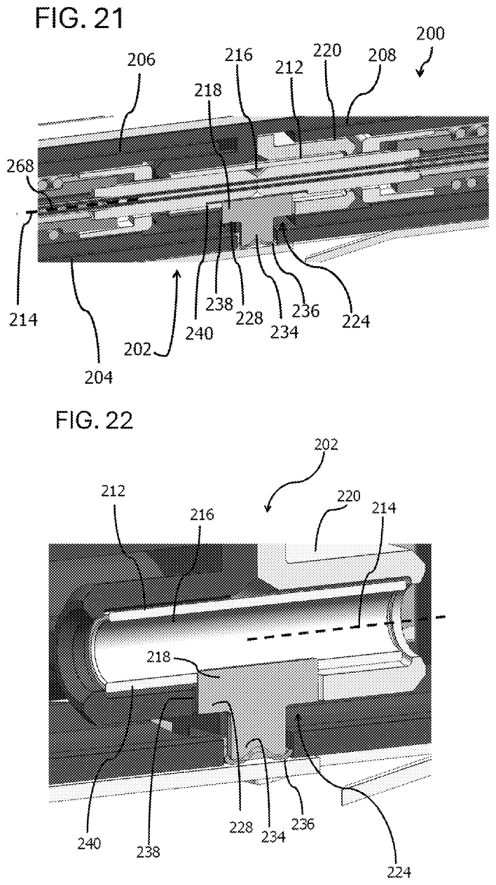

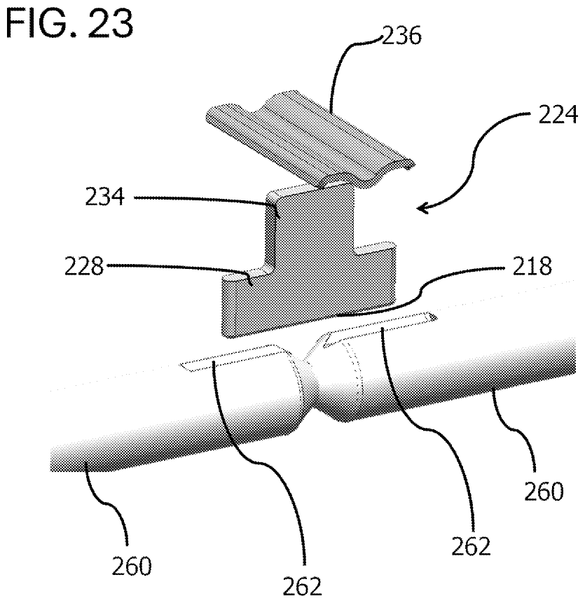

Referring to FIGS. 16-23, another example embodiment of a fiber optic connection system is generally indicated at reference number 200. The fiber optic connection system 200 comprises an adapter 202 and one or more connectors 250 configured to mate with the adapter 202. The fiber optic connection system 200 is similar to the fiber optic connection system 100 except that the connectors 250 are very small form factor (VSFF) duplex connectors, each having first and second ferrule assemblies 258 with respective orientation-sensitive ferrules 260, and the adapter 202 includes a corresponding pair of ferrule alignment sleeves 212 with respective ferrule alignment keys 218.

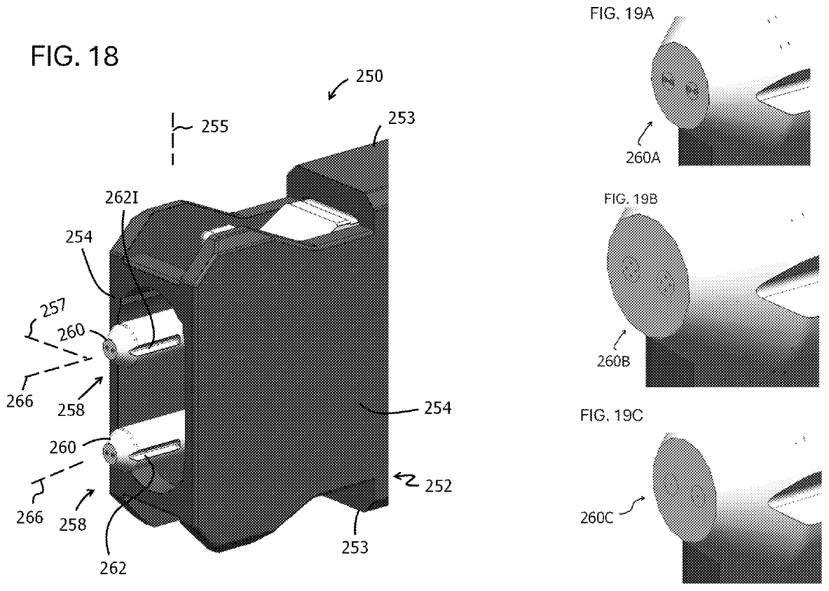

Referring to FIGS. 17 and 18, the connector 250 includes a connector housing 252 of a VSFF type, specifically an SN connector housing. Another VSFF connector housing that may be used without departing from the scope of the disclosure is the MDC connector housing. The connector housing 252 has a narrow side 253 and a broad side 254. The connector 250 defines a ferrule separation axis 255 along which the first and second ferrule assemblies 258 are spaced apart, and a transverse axis 257 perpendicular to the ferrule separation axis 255.

The connector 250 includes first and second ferrule assemblies 258 spaced apart along the ferrule separation axis 255. Each ferrule assembly 258 includes an orientation-sensitive ferrule 260 having a groove 262 serving as a keying surface, a ferrule center axis 266, and a ferrule flange 268. The grooves 262 of the first and second orientation-sensitive ferrules 260 face the broad side 254 such that each groove 262 is centered on an imaginary line parallel to the transverse axis 257 intersecting the respective ferrule center axis 266.

Referring to FIGS. 19A-19C, two additional orientation-sensitive ferrule configurations are illustrated in the context of the second embodiment. FIG. 19A shows a fifth orientation-sensitive ferrule configuration in which each orientation-sensitive ferrule 260A holds two PANDA-type polarization maintaining fibers. The two PANDA fibers are arranged side by side within the ferrule, and the groove 262 is oriented with respect to the slow axes of the polarization maintaining fibers. FIG. 19B shows a sixth orientation-sensitive ferrule configuration in which each orientation-sensitive ferrule 260B holds two multicore fibers. The two multicore fibers are arranged side by side within the ferrule, and the groove 262 is oriented with respect to the core arrangement of the multicore fibers. FIG. 19C shows another orientation-sensitive ferrule configuration 260C in which each orientation-sensitive ferrule holds a plurality of individual optical fibers arranged in a pattern within the ferrule. The individual fibers may be conventional single-mode or multimode fibers, and the groove 262 is oriented with respect to the fiber arrangement to ensure proper alignment of each fiber with its corresponding fiber in a mating ferrule.

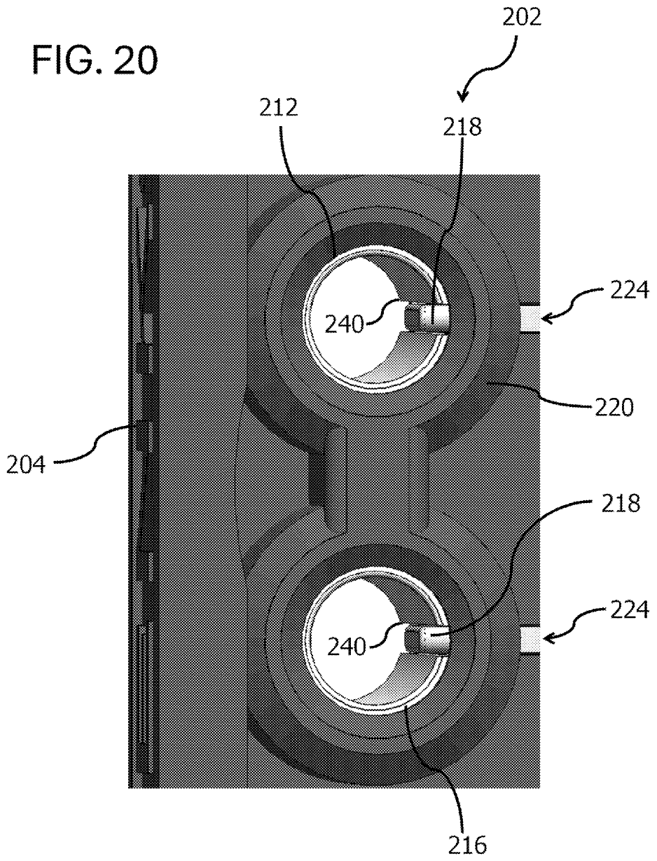

Referring to FIGS. 20-23, the adapter 202 includes an adapter housing 204 defining a first receptacle 206 and a second receptacle 208. Within the adapter housing 204, first and second ferrule alignment sleeves 212 are disposed. Each defines a ferrule alignment axis 214 and has an interior 216. An alignment sleeve holder 220 holds the ferrule alignment sleeves 212 within the adapter housing 204. A ferrule alignment key 218 is disposed in the interior 216 of each ferrule alignment sleeve 212. As in the previous embodiment, each ferrule alignment key 218 is defined by an inner flange 228 of an alignment plate 224 and the alignment plate 224 further includes a web 234 extending from the inner flange 228. A spring 236 yieldably biases each ferrule alignment key 218 radially inward toward engagement with the ferrule assemblies 258. The alignment sleeve holder 220 defines an outer slot 238 and each ferrule alignment sleeve 212 defines an inner slot 240, with the outer slot 238 and the inner slot 240 aligned to receive the alignment plate 224 such that the ferrule alignment key 218 protrudes into the interior 216. Operation of the fiber optic connection system 200 is analogous to the operation of the fiber optic connection system 100 described above with reference to FIGS. 1-15B, with each pair of mating orientation-sensitive ferrules 260 being concentrically aligned within a respective ferrule alignment sleeve 212 and rotationally aligned by the ferrule alignment key 218.

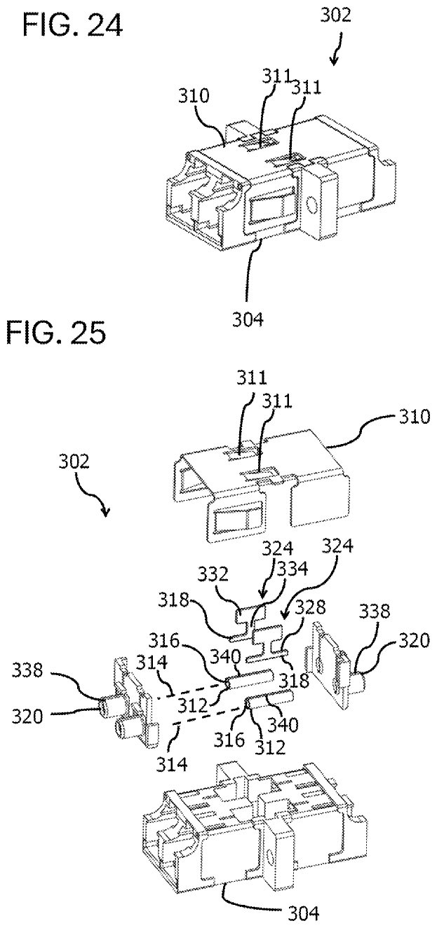

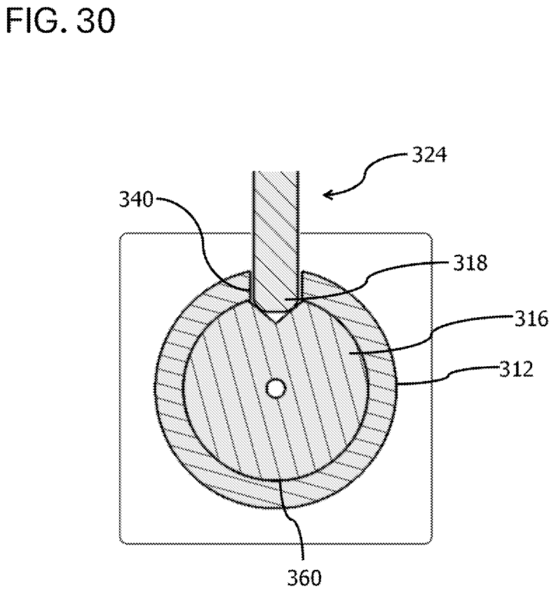

Referring to FIGS. 24-31C, another example embodiment of a fiber optic connection system is generally indicated at reference number 300. The fiber optic connection system 300 comprises an adapter 302 and one or more connectors 350 configured to mate with the adapter 302. The fiber optic connection system 300 is similar to the fiber optic connection system 100 except that the alignment plate 324 has an I-shaped, rather than inverse T-shaped, configuration with distinct inner flange, outer flange, and web portions, and the adapter 302 includes a mount clip 310 having a spring tab 311 that biases the ferrule alignment key 318 radially inward.

Referring to FIGS. 24 and 25, the adapter 302 includes an adapter housing 304 and the mount clip 310. The mount clip 310 includes the spring tab 311 configured to yieldably bias the ferrule alignment key 318 radially inward toward engagement with the ferrule assemblies 358. The spring tab 311 serves the same function as the spring 136 in the first embodiment but is integrally formed with the mount clip 310 rather than being a separate spring element. The mount clip 310 is a metal clip, and the spring tab 311 is a tab folded inward from another panel of the mount clip 310. Because of the resilience of the metal clip material, the spring tab 311 functions as a leaf spring, providing a biasing force against the alignment plate 324.

Within the adapter housing 304, a ferrule alignment sleeve 312 is disposed, defining a ferrule alignment axis 314 and having an interior 316. An alignment sleeve holder 320 holds the ferrule alignment sleeve 312 within the adapter housing 304. The alignment sleeve holder 320 defines an outer slot 338 and the ferrule alignment sleeve 312 defines an inner slot 340. An alignment plate 324 is received in the outer slot 338 and the inner slot 340 such that the ferrule alignment key 318 protrudes into the interior 316 of the ferrule alignment sleeve 312.

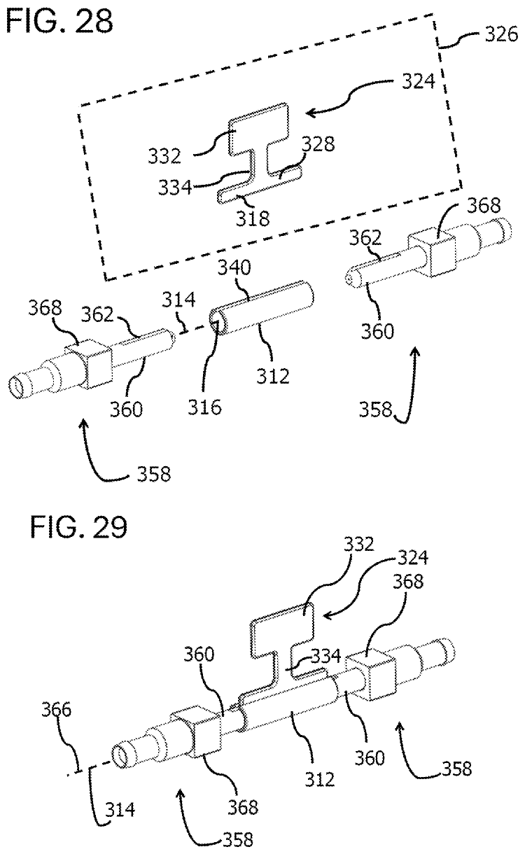

Referring to FIGS. 25 and 28, the alignment plate 324 extends in a plate plane 326 and has an I-shaped configuration. The alignment plate 324 comprises an inner flange 328 proximate to the ferrule alignment axis 314, an outer flange 332 distal from the ferrule alignment axis 314, and a web 334 connecting the inner flange 328 and the outer flange 332. The inner flange 328 has an inner edge margin defining the ferrule alignment key 318, which is configured to engage the groove 362 of each ferrule assembly 358. The web 334 is narrower than the inner flange 328 and the outer flange 332 to define a clearance for the rim 356 of the connector housing 352. The clearance provided by the web 334 allows the rim 356 to pass adjacent to the alignment plate 324 without interference when the ferrule alignment key 318 is engaged with the grooves 362. The outer flange 332 provides a bearing surface against which the spring tab 311 of the mount clip 310 acts to bias the ferrule alignment key 318 radially inward.

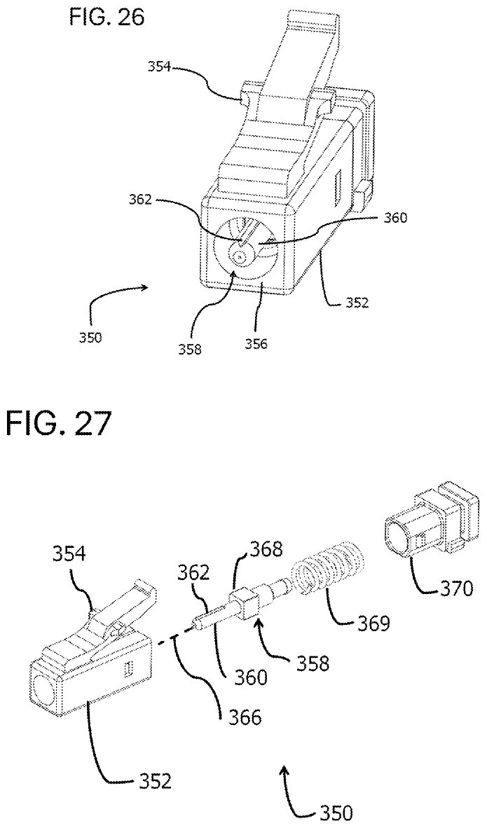

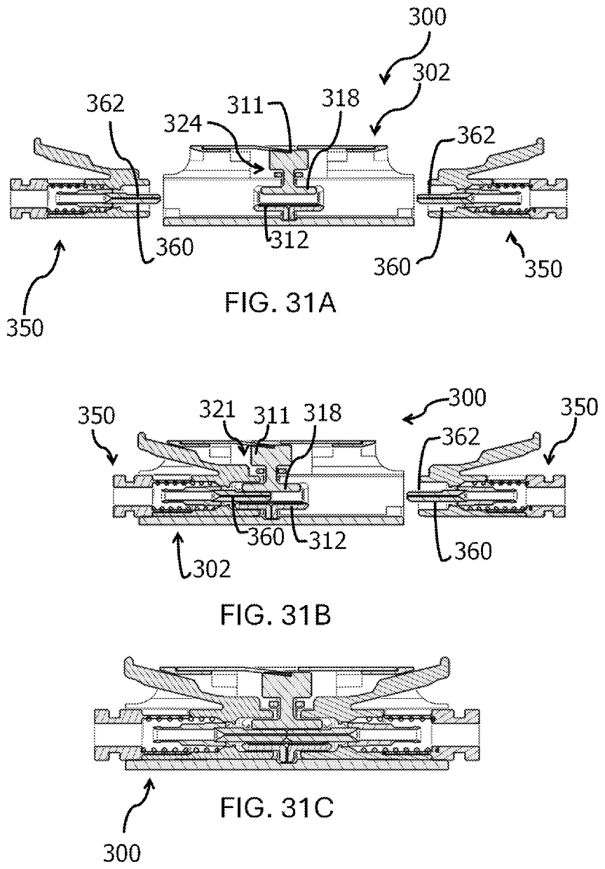

Referring to FIGS. 26, 27, and 31A-31C, the connector 350 includes a connector housing 352 configured as an LC plug frame having a connector latch feature 354 and a rim 356. The ferrule assembly 358 includes an orientation-sensitive ferrule 360 having a groove 362 on the ferrule body serving as a keying surface, a ferrule center axis 366, a ferrule flange 368, a ferrule spring 369, and a back body 370. The ferrule spring 369 biases the orientation-sensitive ferrule 360 axially forward within the connector housing 352 to provide compliance during mating. Operation of the fiber optic connection system 300 is analogous to the operation of the fiber optic connection system 100 described above with reference to FIGS. 1-15B, as illustrated in the mating sequence shown in FIGS. 31A-31C.

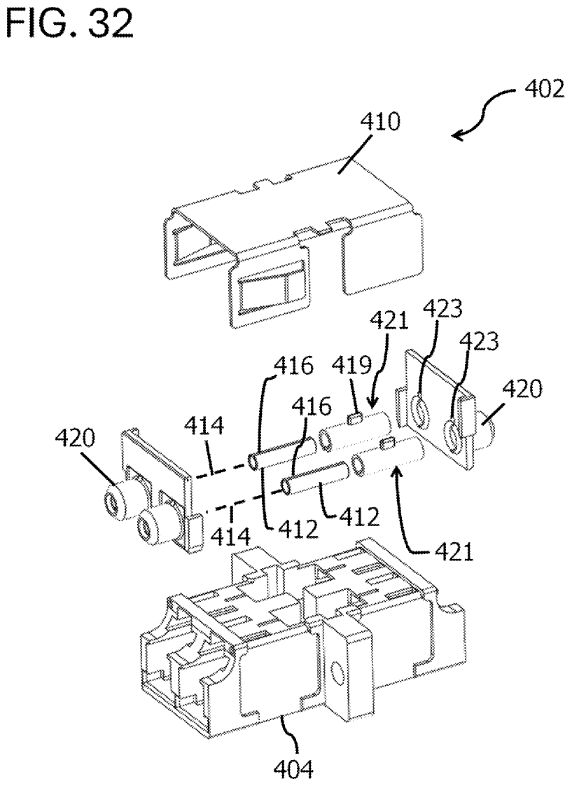

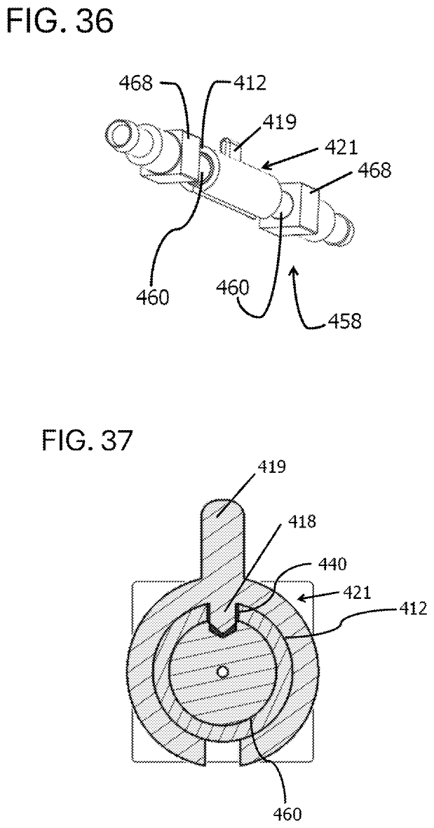

Referring to FIGS. 32-38C, another example embodiment of a fiber optic connection system is generally indicated at reference number 400. The fiber optic connection system 400 comprises an adapter 402 and one or more connectors 450 configured to mate with the adapter 402. The fiber optic connection system 400 is similar to the fiber optic connection system 300 except that the ferrule alignment key 418 is formed as an integral tongue of an alignment sleeve sheath 421 rather than as part of a separate alignment plate and the connector housing 452 comprises an LC plug frame with an enlarged ferrule opening 453.

Referring to FIGS. 32 and 35-37, the adapter 402 includes an adapter housing 404, a mount clip 410, and an alignment sleeve holder 420. A ferrule alignment sleeve 412 is disposed within the alignment sleeve holder 420, defining a ferrule alignment axis 414 and having an interior 416. An alignment sleeve sheath 421 surrounds the ferrule alignment sleeve 412. The alignment sleeve sheath 421 includes an alignment tab 419 that engages an alignment tab receiver 423 on the alignment sleeve holder 420 to secure the alignment sleeve sheath 421 in position. The ferrule alignment key 418 is formed as an integral tongue of the alignment sleeve sheath 421 that protrudes radially inward through a slot 440 in the ferrule alignment sleeve 412 into the interior 416. The ferrule alignment key 418 is configured to engage the groove 462 of each ferrule assembly 458 to rotationally align the orientation-sensitive ferrules 460. Because the ferrule alignment key 418 is integral with the alignment sleeve sheath 421, no separate alignment plate is required.

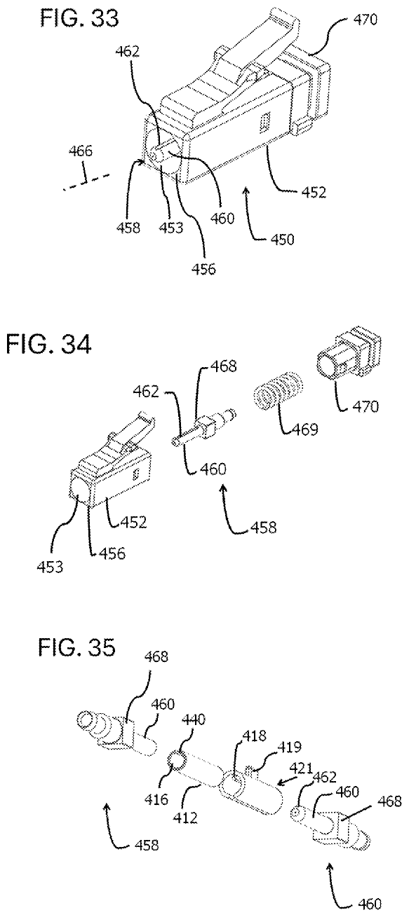

Referring to FIGS. 33 and 34, the connector 450 includes a connector housing 452 configured as an LC plug frame with a rim 456 that defines an enlarged ferrule opening 453. In one or more embodiments, the enlarged ferrule opening 453 has a cross-sectional area in an inclusive range of from 8.1 mm² to 12.6 mm² (e.g., 8.5 mm² to 12.6 mm², 9 mm² to 12.6 mm², or 10 mm² to 12.6 mm²). Those skilled in the art will appreciate that the cross-sectional area of the enlarged ferrule opening 453 is thus greater than the maximum cross-sectional area of the same opening in a conventional LC connector. The enlarged ferrule opening 453 accommodates the alignment sleeve holder 420 with the alignment sleeve sheath 421 on which the ferrule alignment key 418 is integrally formed. As with the previous embodiments, the ferrule assembly 458 includes an orientation-sensitive ferrule 460 having a groove 462 on the ferrule body serving as a keying surface, a ferrule center axis 466, a ferrule spring 469, and a back body 470.

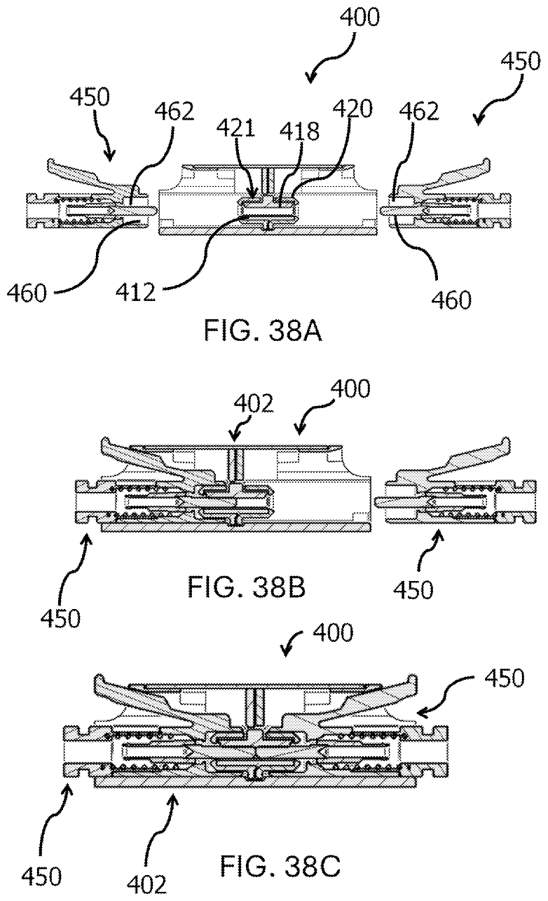

Operation of the fiber optic connection system 400 is analogous to the operation of the fiber optic connection system 100 described above with reference to FIGS. 1-15B, as illustrated in the mating sequence shown in FIGS. 38A-38C. As the connectors 450 are inserted into the adapter 402, the orientation-sensitive ferrules 460 enter the ferrule alignment sleeve 412 from opposite ends and are concentrically aligned along the ferrule alignment axis 414. The integral tongue of the alignment sleeve sheath 421 defining the ferrule alignment key 418 engages the grooves 462 on both orientation-sensitive ferrules 460 to rotationally align the ferrules and establish an optical connection.

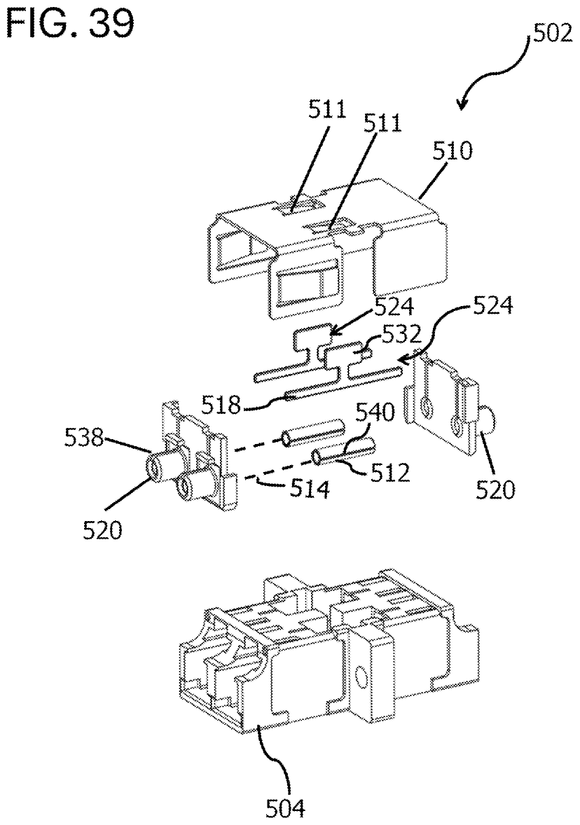

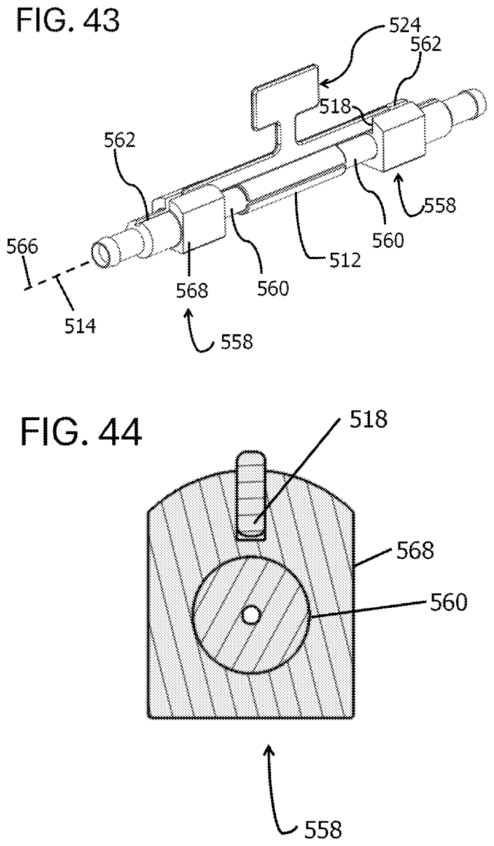

Referring to FIGS. 39-45C, another example embodiment of a fiber optic connection system is generally indicated at reference number 500. The fiber optic connection system 500 comprises an adapter 502 and one or more connectors 550 configured to mate with the adapter 502. The fiber optic connection system 500 is similar to the fiber optic connection system 300 except that the groove 562 is located on a ferrule flange 568 of the ferrule assembly 558 rather than on the cylindrical body of the orientation-sensitive ferrule 560, and the connector housing 552 comprises an LC plug frame with an internal groove 553 to accommodate the ferrule alignment key 518 engaging the ferrule flange 568.

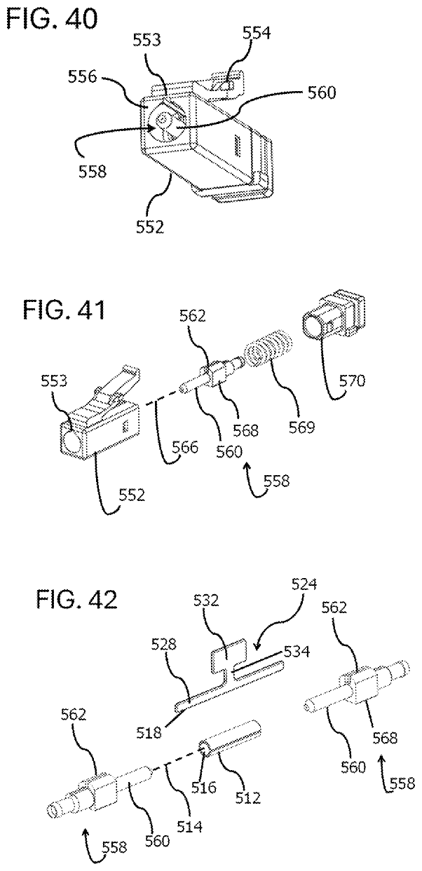

Referring to FIGS. 40 and 41, the connector 550 includes a connector housing 552 configured as an LC plug frame having a connector latch feature 554 and a rim 556. The connector housing 552 includes the internal groove 553 formed within the connector housing 552. The ferrule assembly 558 includes an orientation-sensitive ferrule 560 having a ferrule center axis 566, a ferrule flange 568, a ferrule spring 569, and a back body 570. In this embodiment, the groove 562 serving as a keying surface is located on the ferrule flange 568 rather than on the cylindrical body of the orientation-sensitive ferrule 560. The internal groove 553 in the connector housing 552 provides clearance for the ferrule alignment key 518 to pass through the connector housing 552 and engage the groove 562 on the ferrule flange 568 when the connector 550 is received in the adapter 502.

Referring to FIGS. 39 and 42-44, the adapter 502 includes an adapter housing 504 and a mount clip 510 having a spring tab 511. The spring tab 511 of the mount clip 510 yieldably biases the ferrule alignment key 518 radially inward toward engagement with the ferrule assemblies 558. A ferrule alignment sleeve 512 is disposed within an alignment sleeve holder 520, defining a ferrule alignment axis 514 and having an interior 516. The alignment sleeve holder 520 defines an outer slot 538 and the ferrule alignment sleeve 512 defines an inner slot 540. The alignment plate 524 comprises an inner flange 528, an outer flange 532, and a web 534 connecting the inner flange 528 and the outer flange 532. The inner flange 528 has a greater length along the ferrule alignment axis 514 than in the preceding embodiment so that the ferrule alignment key 518 can reach the groove 562 formed in each ferrule flange 568. Because the groove 562 is on the ferrule flange 568, the ferrule alignment key 518 engages the groove 562 at a location axially rearward of the cylindrical body of the orientation-sensitive ferrule 560, adjacent to the rim 556 of the connector housing 552.

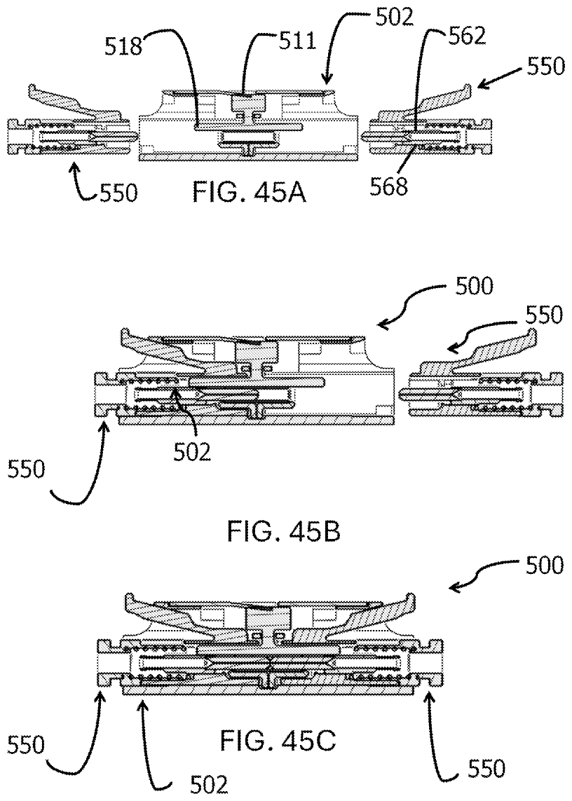

Referring to FIGS. 45A-45C, operation of the fiber optic connection system 500 is analogous to the operation of the fiber optic connection system 100 described above with reference to FIGS. 1-15B. As the connectors 550 are inserted into the adapter 502, the orientation-sensitive ferrules 560 enter the ferrule alignment sleeve 512 from opposite ends and are concentrically aligned along the ferrule alignment axis 514. The ferrule alignment key 518 engages the grooves 562 on the ferrule flanges 568 of both ferrule assemblies 558 to rotationally align the orientation-sensitive ferrules 560 and establish an optical connection. The internal groove 553 in each connector housing 552 provides the necessary clearance for the ferrule alignment key 518 to reach and engage the groove 562 on the ferrule flange 568.

The fiber optic connection systems 100, 200, 300, 400, and 500 described herein provide alignment structures configured to concentrically and rotationally align orientation-sensitive ferrules for multicore fiber, polarization maintaining fiber, and guide pin-free multi-fiber applications. The ferrule alignment sleeve in each embodiment receives orientation-sensitive ferrules from mating connectors and concentrically aligns the orientation-sensitive ferrules on a ferrule alignment axis. The ferrule alignment key disposed in the interior of the ferrule alignment sleeve engages grooves on the ferrule assemblies to rotationally align the orientation-sensitive ferrules and establish an optical connection. The various embodiments demonstrate flexibility in the configuration of the ferrule alignment key and the groove on the ferrule assembly. In the fiber optic connection systems 100 and 200, the ferrule alignment key is defined by an inner edge margin of an alignment plate having an inverse T-shaped configuration with an inner flange and a web. In the fiber optic connection system 300, the alignment plate has an I-shaped configuration with distinct inner flange, outer flange, and web portions, and a spring tab of a mount clip biases the ferrule alignment key radially inward. In the fiber optic connection system 400, the ferrule alignment key is formed as an integral tongue of an alignment sleeve sheath rather than as part of a separate alignment plate. In the fiber optic connection system 500, the groove is located on a ferrule flange of the ferrule assembly rather than on the cylindrical body of the orientation-sensitive ferrule. The fiber optic connection systems described herein are compatible with various connector form factors including LC-type connectors and very small form factor duplex connectors such as SN-type connectors. The alignment structures accommodate orientation-sensitive ferrules holding polarization maintaining fibers, multicore fibers, and multi-fiber ferrule arrangements, as well as orientation-insensitive ferrules holding conventional single-core optical fibers.

A number of implementations have been described. Nevertheless, it will be understood that various modifications may be made without departing from the spirit and scope of the disclosure. Accordingly, other implementations are within the scope of the following claims.

1. An adapter for fiber optic connectors, the adapter comprising:
an adapter housing defining a first receptacle and a second receptacle, the first receptacle configured to receive a first connector and the second receptacle configured to receive a second connector, wherein the first connector comprises a first ferrule assembly including a first orientation-sensitive ferrule and wherein the second connector comprises a second ferrule assembly including a second orientation-sensitive ferrule;
an adapter latch feature for latching with a complementary connector latch feature on a connector housing of the first connector to secure the first connector in the first receptacle;
a ferrule alignment sleeve disposed within the adapter housing and defining a ferrule alignment axis, the ferrule alignment sleeve having an interior, the ferrule alignment sleeve configured to receive the first orientation-sensitive ferrule and the second orientation-sensitive ferrule and concentrically align the first orientation-sensitive ferrule and the second orientation-sensitive ferrule on the ferrule alignment axis; and
a ferrule alignment key disposed in the interior of the ferrule alignment sleeve, the ferrule alignment key configured to engage a groove of the first ferrule assembly and a groove of the second ferrule assembly to rotationally align the first orientation-sensitive ferrule and the second orientation-sensitive ferrule to establish an optical connection when the first connector is received in the first receptacle and the second connector is received in the second receptacle.

2. The adapter of claim 1, wherein the ferrule alignment key is spring-loaded.

3. The adapter of claim 2, further comprising a panel clip, wherein the panel clip is configured to yieldably bias the ferrule alignment key radially inward relative to the ferrule alignment axis toward engagement with the first ferrule assembly and the second ferrule assembly.

4. The adapter of claim 2, further comprising a spring element in the adapter housing configured to yieldably bias the ferrule alignment key radially inward relative to the ferrule alignment axis toward engagement with the first ferrule assembly and the second ferrule assembly.

5. The adapter of claim 1, further comprising an alignment plate extending in a plate plane, the ferrule alignment axis lying on the plate plane, the alignment plate having an inner edge margin defining the ferrule alignment key.

6. The adapter of claim 5, further comprising an alignment sleeve holder defining an outer slot and wherein the ferrule alignment sleeve is held in the alignment sleeve holder and defines an inner slot, the outer slot and the inner slot being aligned with the plate plane, the alignment plate being received in the outer slot and the inner slot such that the ferrule alignment key protrudes from the outer slot and the inner slot into the interior of the ferrule alignment sleeve.

7. The adapter of claim 1, further comprising an alignment sleeve sheath comprising an internal tongue defining the ferrule alignment key.

8. The adapter of claim 1, wherein the adapter comprises an LC adapter.

9. The adapter of claim 1, wherein the adapter comprises an SN adapter.

10. A connector for fiber optic applications, the connector comprising:
a connector housing having a latch feature;
a ferrule assembly in the connector housing, the ferrule assembly including an orientation-sensitive ferrule; and
a keying surface on the ferrule assembly, the keying surface configured to engage a ferrule alignment key disposed inside a ferrule alignment sleeve to rotationally align the ferrule assembly with a mating ferrule assembly.

11. The connector of claim 10, wherein the keying surface defines a groove on the ferrule assembly.

12. The connector of claim 11, wherein the groove is V-shaped in cross section.

13. The connector of claim 10, wherein the orientation-sensitive ferrule has a length including a leading half and a trailing half and wherein the keying surface is located entirely along the leading half.

14. The connector of claim 10, wherein the connector housing comprises an LC plug frame comprising a rim defining an opening having a cross-sectional area in an inclusive range of from 8.1 mm² to 12.6 mm².

15. The connector of claim 10, wherein the connector housing comprises an LC plug frame having an internal groove, and wherein the keying surface defines a groove in a ferrule flange of the ferrule assembly.

16. The connector of claim 10, wherein the connector housing comprises an LC plug frame having a latch arm, the ferrule assembly having a ferrule center axis, wherein an alignment plane is positioned so that the ferrule center axis, the latch arm, and groove lie in the alignment plane.

17. The connector of claim 10, wherein the connector housing comprises a very small form factor (VSFF) duplex connector housing having a first narrow side and a second narrow side spaced apart along a ferrule separation axis and a first broad side and a second broad side spaced apart along a transverse axis perpendicular to the ferrule separation axis, and wherein the connector further comprises a second orientation-sensitive ferrule spaced apart from the first orientation-sensitive ferrule along the ferrule separation axis, the keying surface of the first orientation-sensitive ferrule defining a first groove, the second orientation-sensitive ferrule having a keying surface defining a second groove, the first orientation-sensitive ferrule having a first ferrule center axis, the second orientation-sensitive ferrule having a second ferrule center axis, the first groove facing the first broad side such that the first groove is centered on an imaginary line parallel to the transverse axis intersecting the first ferrule center axis, the second groove facing the first broad side such that the second groove is centered on an imaginary line parallel to the transverse axis intersecting the second ferrule center axis.

18. A fiber optic connection system comprising:
a first connector comprising a first connector housing and a first ferrule assembly including a first orientation-sensitive ferrule, the first ferrule assembly having a first keying surface defining a first groove;
a second connector comprising a second connector housing and a second ferrule assembly including a second orientation-sensitive ferrule, the second ferrule assembly having a second keying surface defining a second groove; and
an adapter comprising:
an adapter housing defining a first receptacle and a second receptacle, the first receptacle configured to receive the first connector and the second receptacle configured to receive the second connector;
a ferrule alignment sleeve disposed within the adapter housing and defining a ferrule alignment axis, the ferrule alignment sleeve having an interior, the ferrule alignment sleeve configured to receive the first orientation-sensitive ferrule and the second orientation-sensitive ferrule and concentrically align the first orientation-sensitive ferrule and the second orientation-sensitive ferrule on the ferrule alignment axis; and
a ferrule alignment key disposed in the interior of the ferrule alignment sleeve, the ferrule alignment key configured to engage the first groove of the first ferrule assembly and the second groove of the second ferrule assembly to rotationally align the first orientation-sensitive ferrule and the second orientation-sensitive ferrule to establish an optical connection when the first connector is received in the first receptacle and the second connector is received in the second receptacle.

19. The fiber optic connection system of claim 18, wherein the first groove and the second groove each are V-shaped in cross-section.

20. The fiber optic connection system of claim 18, wherein the first connector housing has a first rim and the second connector housing has a second rim, and the adapter comprises an alignment plate having an inboard edge margin and an outboard edge margin, the inboard edge margin defining the ferrule alignment key, the alignment plate defining a web upstanding from the ferrule alignment key, the alignment plate defining first and second clearance notches on opposite sides of the web above the ferrule alignment key, the first clearance notch and the second clearance notch configured to provide clearance for the first rim and the second rim when the ferrule alignment key is engaged with the first groove and the second groove.
